(19) United States
(12) Patent Application Publication
(10) Pub. No.: US 2011/0165301 A1
(43) Pub. Date: Jul. 7, 2011

(54) MIXTURE OF CHIPS AND METHOD FOR PRODUCING SAME

(75) Inventor: Marco BLUMENTHAL, Baden (CH)

(73) Assignee: Zweifel Pomy-Chips AG.

(21) Appl. No.: 12/985,096

(22) Filed: Jan. 5, 2011

(30) Foreign Application Priority Data
Jan. 7, 2010 (EP) 10 000 072.8
Dec. 22, 2010 (EP) 10 015 938.3

(51) Int. Cl. A23L 1/00; A23B 4/03

(52) U.S. Cl. 426/531; 426/465

(57) ABSTRACT

A method for producing dehydration products, in particular chips with which the color and the flavor are retained to a large extent comprises a final dehydration step or drying step, respectively, wherein products, such as chips, with a water content of at most 15% by weight are dehydrated at temperatures below 80° C. using a dehydration means. Preferred dehydration means are also products like chips wherein these products have been dried to a water content of preferably less than 2% by weight, in particular about 1% by weight or less. This method is e.g. well suited for the production of compositions comprising meat chips and/or vegetable chips with potato chips and/or cereal chips.

### CROSS REFERENCE TO RELATED APPLICATIONS

This application claims the priority of European patent applications nos. 10 000 072.8, filed Jan. 7, 2010, and 10 015 938.3, filed Dec. 22, 2010 the disclosures of which are incorporated herein by reference in their entirety.

### FIELD OF THE INVENTION

The present invention relates to the production of dehydrated, i.e. dried and/or deep-fried products such as foodstuff snacks, in particular the production of such snacks like snacks with vegetable chips, fruit chips, meat chips, fish chips and compositions thereof.

### BACKGROUND OF THE INVENTION

Several methods for manufacturing chips, in particular potato chips, are known. The most common of these methods is the production of chips via deep-frying of thin potato slices. Since fried potato chips are on the one hand characterized by their good flavor and pleasant organoleptic features, on the other hand by a high fat content, for many years research in this field has aimed and still aims at reducing the fat content while conserving flavor and organoleptic features (see e.g. WO 99/04650). Such methods for producing fat-reduced or low-fat products comprise roasting method as well as drying or dehydration methods like fluidized bed dryers or belt dryers with or without previously or subsequently performed deep-frying step.

Also already known are snack products produced from dough, e.g. deep-fried or dried products based on potatoes and/or cereals that may be formed into a broad variety of different shapes such as slice-like shapes, usually referred to as chips, or pellets.

While all these methods result in more or less good accepted crispy snacks like vegetable chips, in particular potato chips, and fruit chips, in particular apple chips, they are not suitable for many vegetable products, fruit products and meat products since they result in reduced flavor or loss of flavor and/or off-flavors and/or in reduced or changed color, resulting in a diminished acceptance of the chip product.

From EP 0 935 972 a potato product is known that may be rehydrated, said product being produced in that small blanched potato pieces are glued together and then dried at temperatures below 110° C., usually with decreasing temperature, to a water content of less than 10% by weight such as 7-8% by weight. This product is not intended for being consumed as dehydrated product (snack) but for consumption in rehydrated (and optionally further processed, e.g. deep-fried) condition.

### BRIEF SUMMARY OF THE INVENTION

Hence, it is a general object of the invention to provide a method for the manufacturing or production of a dehydrated (dried or dry) product of a first kind, usually a snack product, in particular a chips product and a chips composition, as well as a dehydrated (dry) product, usually a snack product, in particular a chips product and a chips composition comprising at least a portion of a product of a first kind that is selected from vegetable pieces and/or fruit pieces and/or meat pieces or fish pieces and/or cereal pieces with good retention of the flavor and/or the color.

Now, in order to implement these and still further objects of the invention, which will become more readily apparent as the description proceeds, the method for the production of product of a first kind by dehydration is manifested by the features that in a final drying or dehydration step product of a first kind with a water content of at least 5% by weight and at most 15% by weight is dehydrated at a temperature of less than 80° C., in particular less than 60° C., much preferred at ambient temperature, at least partially by means of a product of a second kind.

The product of a first kind comprises vegetable pieces and/or fruit pieces and/or meat pieces and/or fish pieces and or dough pieces, in particular vegetable chips and/or fruit chips and/or meat chips and/or fish chips.

The product of a second kind comprises vegetable pieces and/or fruit pieces and/or dough pieces, in particular vegetable chips and/or fruit chips and/or dough chips, with a water content of less than 3% by weight, preferably at most 2% by weight, in particular about 1% by weight.

A further object of the present invention is a composition of dehydration product obtainable or obtained by the inventive method.

Also an object of the present invention is a composition of dehydration products wherein

(i) the mean water content is 1 to 4% by weight, in particular 1.5 to 4% by weight, much preferred 2 to 3% by weight, and

(ii) said dehydration product comprises at least two kinds of products whereof one is not potato chips and/or whereof one is deep-fried and one is only partially deep-fried or preferably not deep-fried.

In a preferred embodiment such composition dehydration products is produced according to the method of the present invention.

### BRIEF DESCRIPTION OF THE DRAWINGS

Examples for the shapes of the products of a first kind and the products of a second kind are shown in the Figures, wherein:

FIG. 1 shows a slice-like embodiment, also referred to as chips;

FIG. 2 shows a rod-like embodiment;

FIG. 3 shows a wedge-like embodiment, and

FIG. 4 shows a pellet-like embodiment.

### DETAILED DESCRIPTION OF THE INVENTION

The problem of the invention was solved by a method for producing a dry product, in particular chips (further on also referred to as product of a first kind) via dehydration, wherein product of a first kind with a water content of at least about 5% by weight and at most about 15% by weight is dehydrated in a final drying step at a temperature below about 80° C., preferably below about 60° C., especially at ambient temperature, said dehydration being performed at least partially by means of product of a second kind as defined below.

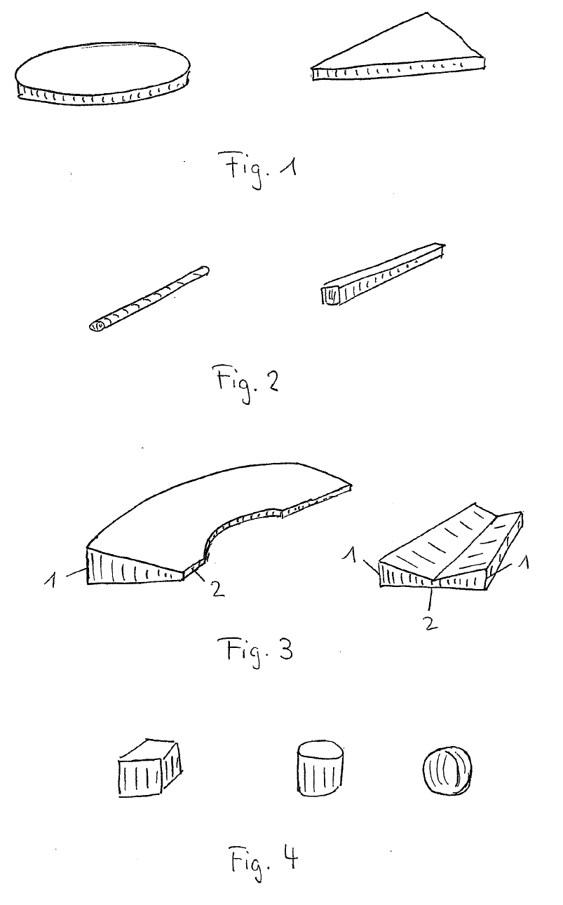

In the scope of this invention, dehydrated or dry product means a foodstuff in form of pieces wherein the pieces may be slice-shaped (see FIG. 1) and/or rod-shaped (see FIG. 2) and/or wedge-shaped like e.g. apple wedges (see FIG. 3) and/or pellet-shaped (see FIG. 4). The term slice-shaped is used for a form with the extent in two directions being much larger than in the third direction, usually at least five times larger, and which has an essentially constant thickness (see FIG. 1). Slice-shaped products are also termed chips, e.g. potato chips. The term rod-shaped designates a form wherein one dimension is essentially longer than the dimensions in the other two directions, usually at least twice as long as the longer dimension in the other two directions, while also in this embodiment the diameter remains essentially constant (see FIG. 2). An example for rod-shaped is the shape of the main part of pommes frites. The term wedge-shaped designates a form wherein at least the smallest dimension, the thickness, varies. Usually the thickness increases or decreases in a more or less continuous manner (see FIG. 3). Most prominent representative of this form are apple wedges or potato wedges. The term pellet-shaped designates all forms, wherein the three dimensions are similar (see FIG. 4). All these forms may be more or less favored dependent on the foodstuff concerned.

In the scope of this invention the terms “product of a first kind” and “product of a second kind” comprise compositions of different vegetable, different fruit, different meat or different fish and different cereals as well as any combination of vegetable and/or fruit and/or meat and/or fish and/or cereals.

In the scope of this invention, ambient temperature means a temperature of about 10° C. to about 40° C., in particular from 20° C. to 35° C. The term room temperature is used in its usual meaning as 25° C.

The final dehydration or drying step may be performed in one step or divided into more than one partial steps, e.g. two partial steps with the same or different dehydration means, wherein one dehydration means, usually the last used dehydration means or at least one of the last used dehydration means is product of a second kind (see below).

Methods for an antecedent dehydration are e.g. dehydration methods working at high temperatures, such as above 100° C., like deep-frying methods and/or other dehydration methods with which a pre-drying down to a water content of at most about 15% by weight, preferably down to about 8 to about 10% by weight is performed. In the case of especially sensitive products, that may already suffer discoloration and/or undesired flavor changes at temperatures above 100° C. in wet state, already the pre-drying step may have to be performed at lower temperatures, e.g. at temperatures from 80° C. to 100° C. with respectively longer dehydration times.

Using the method described for the final drying step also products with higher water content may directly be dried; however, in an economic view, such method is not interesting because of the large amount of drying means and/or the long duration, respectively.

The products of a first kind may be vegetable chips and/or fruit chips and/or meat chips and/or fish chips. Vegetable or fruit suitable as products of a first kind may also be wedges, which is not preferred for meat and fish. The products of a first kind may also be dough products or they may contain dough, in particular if the dough comprises food-stuff that is sensitive to discoloration or changes in flavor. The designation product of a first kind, as it is used in the scope of the invention comprises compositions of chips and/or wedges of different kinds of vegetable, compositions of chips and/or wedges of different kinds of fruit, compositions of chips of different kinds of meat and/or fish, compositions of dough products in same or different forms as well as compositions of vegetable and/or fruit and/or meat or fish, respectively, and/or dough products.

Meat chips and fish chips are preferably pre-dried by means of a two steps procedure. In said two steps procedure a further step is provided that is performed before the usual pre-drying step. This further, first step is an air-drying step of the whole (not yet cut) piece of meat or fish to a water content of less than 70% by weight, usually less than 60% by weight, preferably less than 50% by weight and especially to a water content of about 50% by weight. Then the air-dried meat or the air-dried fish is cut into slices of a thickness of at most 2 mm, preferably 0.3 to 1 mm, in particular 0.5 to 0.7 mm. These slices are dried in a dryer to a water content of at most 15% by weight, preferably a water content of 5 to 12% by weight, especially preferred a water content of 8 to 10% by weight.

If the products of a first kind are vegetable chips or fruit chips, the vegetable and/or fruit is cut into slices of a pre-dried thickness of at most 2 mm, in particular 0.5 to 1 mm, prior to subjecting the slices or chips, respectively, to a pre-drying step, optionally after peeling of the not yet cut vegetable or fruit.

If the products of a first kind are sloping vegetable wedges or sloping fruit wedges, the vegetable and/or fruit is cut into wedges prior to the pre-drying step. The pre-dried thickness of such wedges diminishes from a maximal thickness 1 of at most 20 mm, in particular at most 10 mm, or also only at most about 5 mm to a minimal thickness 2 that tends toward 0 wherein the minimal thickness 2 usually is around about 0.5 mm. The cutting may optionally be performed after peeling of the uncut vegetable or fruit.

The dehydration means used according to the present invention, the product of a second kind, consists in dried foodstuff products, in particular chips, that optionally may be used in combination with another dehydration means but preferably are used alone. Further dehydration means are for example molecular sieve and/or silica gel and/or “dry” air. Preferred dehydration means are solid dehydration means.

Products of a second kind are especially vegetable chips or fruit chips or dough products with a water content of less than 3% by weight, preferably at most 2% by weight, in particular about 1% by weight or even less than 1% by weight, for example only about 0.5% by weight. Such products of a second kind may e.g. be produced via a deep-frying method. Preferred vegetable chips of a second kind are potato chips, preferred dough products are for example dough products with potatoes and/or cereals like wheat, corn, rice, oat, barley and compositions thereof that may be deep-fried, baked or dried.

The term product of a second kind, as used in the scope of the present invention, comprises compositions of chips and/or wedges and/or rods of different vegetable, compositions of chips and/or wedges and/or rods of different fruit, compositions of chips and/or wedges and/or rods and/or pellets of different dough products as well as compositions of vegetable and/or fruit and/or dough products.

In order to obtain organoleptically good products or product compositions, respectively, the mean water content of a product composition produced from product of a first kind and product of a second kind should be as low as possible and it should not exceed a water content of about 4% by weight and in particular about 3% by weight. Therefore the mean water content preferably ranges from about 1 to 4% by weight, in particular from 1.5 to 4% by weight and especially from 2 to 3% by weight. This means for a water content of about 3% by weight that in case the product of a first kind is pre-dried to a water content of about 8% by weight and the product of a second kind is dried to a water content of about 1% by weight, at most about 30% by weight product of a first kind may be admixed without using a further dehydration means, while with a product of a first kind that has been pre-dried to 5% by weight about 50% by weight of said product may be admixed. The drying of the product of a first kind with product of a second kind preferably takes place in an air-tight final packaging at storing conditions at ambient temperature, preferably room temperature.

The snacks, in particular chip compositions, obtainable with the inventive method preferably comprise at least one product of a first kind and at least one product of a second kind, wherein at least one product of a second kind preferably consists of potato chips or dough products and/or was subjected to a deep-frying step and preferably is entirely deep-fried.

Below the invention is outlined in more details and further preferred embodiments are specified. As already outlined above, the production of at least part of the product, the product of a first kind, is performed by dehydration at low temperature, in particular at temperatures below about 60° C. such as at room temperature, at least partially by means of product of a second kind.

Suitable as further dehydration means is any dehydration means that is approved for the application in the food preparation like molecular sieves, silica gel or “dry” air, such as air of 50-60° C. Preferred further dehydration means, however, are solid dehydration means.

The product of a second kind that is always used as one of the dehydration means and preferably as the only dehydration means are vegetable pieces and/or fruit pieces and/or dough pieces with low water content, i.e. a water content of less than 3% by weight, preferably at most 2% by weight, such as 1% by weight or 1.2% by weight or even only 0.5% by weight.

Prior to the final drying step, the products of a first kind are preferably pre-dried in form of pieces applying usual methods. In the scope of the invention “in form of pieces” means slice-like or chips-like products (see FIG. 1), rod-like products (see FIG. 2), wedge-like products (see FIG. 3), pellet-like products (see FIG. 4) or combinations thereof.

Suitable pre-drying methods are deep-frying methods and/or drying methods in usual dryers like belt dryers or fluidized bed dryers or (vacuum)microwave dryers, optionally after a blanching step or a cooking step. The water content after the pre-drying step should be as low as possible but not so low that already undesired changes in flavor such as reduced flavor or loss of flavor and/or off-flavors and/or undesired changes in color have been induced. Thus, the optimal humidity or water content, respectively, of the products of a first kind after the pre-drying step is determined by optimizing the characteristics color, flavor and residual humidity (water content). Thus, the residual humidity may vary dependent on the desired features, usually, however it is below 15% by weight and preferably at about 5 to about 12% by weight, in particular at about 8 to about 10% by weight. A water content of less than 5% by weight usually already results in undesired color and flavor changes. Although in the case of pre-drying by deep-frying flavor changes are in general desired, also there the dehydration should at most be performed to a residual water content of about 8% by weight in order to keep the fat uptake of the products, e.g. the chips, low. Above a water content of at least 8% by weight after the pre-drying step, such as from about 8 to about 10% by weight, so far with none of the tested products an undesired color change and/or flavor change has been observed and such a water content can easily be achieved by common dehydration methods. Depending on the kind of the products of a first kind even at water contents of less than about 8% by weight, i.e. at water contents down to e.g. about 7% by weight, no flavor and/or color changes are perceived.

While prior to the pre-drying step vegetable and fruit are most often cut into pieces of slice-like shape (FIG. 1) or wedges (FIG. 3) wherein the thickness of the slices after pre-drying usually is less than 2 mm, preferably in the range of 0.5 to 1 mm, and the wedge thickness varies from e.g. a maximal thickness 1 of about 20 mm to a minimal thickness 2 of about 0.5 mm, a two step procedure proved to be preferred in the case of meat chips.

Therein the usually already spiced meat is air-dried as a whole (uncut) piece. After air-drying, the water content should be less than 60% by weight, preferably less than 50% by weight and, for economic reasons, around about 50% by weight. In analogy to vegetable and fruit the thus pre-dried whole piece of meat is then cut into pieces of slice-like shape wherein for meat a thickness of the meat pieces of at most 2 mm, preferably of 0.3 to 1 mm and in particular a thickness in the range of 0.5 to 0.7 mm proved to be suitable. These meat pieces are then subjected to the pre-drying step, usually in a dryer such as a belt dryer or a fluidized bed dryer. If a specific flavor shall be generated also a deep-frying step is possible. The pre-drying is performed down to a water content of at most about 15% by weight, preferably to a water content of about 5 to 12% by weight, in particular about 8 to 10% by weight.

The air-drying (and optionally the pretreatment) is performed similarly to the drying of the well known Swiss dried beef specialty “Bündnerfleisch”. “Bündnerfleisch” is made of a piece of cured beef from which the fat and the sinews have been removed. Before drying, the meat is treated with salt, salpeter and spices and stored for some weeks at a temperature close to the freezing point in a closed container. Then the meat is dried for several weeks. During this drying step the meat is repeatedly pressed in order to evenly distribute the remaining liquid.

Instead of beef any other meat may be used such as pork, veal, poultry but also fish.

This method has also proved to be very well suited for drying products, in particular chips of a first kind that are colored vegetable like pumpkin, carrots, blue potatoes or red potatoes, beetroots, zucchini and/or tomatoes. While carrots, blue potatoes or red potatoes, beet-roots, zucchini and tomatoes may only be used as products, in particular chips, of a first kind, pumpkins can easily be dried such that pumpkins, e.g. as chips, may also be used as product or chips, respectively, of a second kind.

The final drying is performed with product of a second kind, optionally together with further solid dehydration means, or with dry air.

The products of a second kind may be produced with common drying methods, in particular by deep-frying or by another dehydration method known in the state of the art, such as backing, roasting, toasting, drying or combinations of these methods. Examples for suitable methods, to name just a few, are e.g. described in the European patent applications EP 100 16 84, EP 893 068 or EP 498 241.

The products of a second kind may also be any vegetable product and/or fruit product and/or dough product as long as the flavor and color changes induced by the total drying are acceptable. However, particularly preferred are vegetable chips, in particular potato chips. Fully dried meat chips may be produced with known methods, however, they are not satisfying with regard to color and flavor and therefore not or badly suited as products, in particular chips, of a second kind.

The products of a second kind are dried to a water content of less than 3% by weight, in particular less than 2% by weight, much preferred to a water content of about 1% by weight or less than 1% by weight, such as 0.5% by weight. For potato chips obtained in a common deep-fryer a water content of e.g. about 1.2% by weight is usual, in a vacuum deep-fryer or in combination with another drying method working at high temperature a lower water content may be obtained.

Prior to the cutting and drying and depending on the intent or desire, the vegetable and the fruit for the products of a first kind and/or the products of a second kind can be peeled prior to cutting or be cut and dried/dehydrated in unpeeled form.

Since dehydrated products, in particular chips, retain their desired organoleptic characteristics like crispiness up to a water content of about 3 to 4% by weight, the compositions of product of a first kind and product of a second kind may be varied within certain limits. Preferably the water content of the products directly after packing—averaged over the whole product—is at most 3% by weight. If the product of a first kind is pre-dried to a water content of 10% by weight and the product of a second kind is dried to 1% by weight, then a product composition of these products may comprise a bit more than 20% by weight product of a first kind at such mean water content of 3% by weight. At a water content of the product of a first kind after pre-drying of 8% by weight and drying of the product of a second kind to 1% by weight, the possible portion or share of product of a first kind amounts to about 30% by weight. At a water content of the product of a first kind after pre-drying of 8% by weight and a water content of the product of a second kind after drying of 2% by weight, the limit for the product of a first kind is a good 15% by weight. At a water content of the product of a first kind after pre-drying of 5% by weight and a water content of the product of a second kind after drying of 1% by weight, the limit for the portion of product of a first kind is at about 50% by weight. Below these limits, the portion of the product of a first kind can be varied as desired, e.g. in view of the color composition, the flavors or based on economic considerations.

Compositions with (i) vegetable pieces and/or fruit pieces, in particular chips, of a first kind, and (ii) vegetable pieces and/or fruit pieces, in particular chips, and/or dough products of a second kind, usually comprise up to 50% by weight product of a first kind, while compositions with (i) meat chips and/or fish chips of a first kind and (ii) vegetable pieces and/or fruit pieces of a second kind usually comprise about 30% by weight product of a first kind only, preferably 20 to 30% by weight.

If reduced crispiness is acceptable or if the final drying step is performed in two partial steps, wherein the products of a first kind are dried in a first partial step to a water content of less than 10 to 8% by weight, for example to a water content of 6% by weight, and in a second partial step are further dried, then the above mentioned limits may be exceeded. The first partial step may e.g. be performed by drying by means of molecular sieve or silica gel or dry air of at most 60° C., or by means of product of a second kind. The second partial step is performed with product of a second kind. If the first partial step has already been performed with product of a second kind, which, however, is not preferred, for the second partial step this product of a second kind is replaced by fresh product of a second kind with a water content of less than 3% by weight, preferably around about 1% by weight.

All information on the weight given above refer to the weight of the product with the water content indicated for product of a first kind or product of a second kind, respectively, suitable for performing the final drying step and not to the weight of the products of a first kind and a second kind in the final product, i.e. after the final drying step or after humidity leveling.

The final drying step or its second partial step, respectively, performed by means of product of a second kind is preferably performed in the final packaging. In view of the usual time elapsing between the end of the manufacturing and the delivery to the consumer a further storage time for ensuring the humidity leveling is rarely needed, since humidity leveling usually is terminated within two days. As an additional support for the final drying, the packaging may have a further drying means integrated. This, however, is only desired or needed in specific cases, e.g. in countries or environments with extremely high ambient humidity or in case of a higher portion of product of a first kind.

Referred to the final product, the product of a first kind usually is present in amounts of about 5 to about 50% by weight, in particular in amounts of 10 to 40% by weight or 15 to 40% by weight. Such amounts may be produced with a one step final drying, i.e. with the admixture of product of a second kind only. From an amount of about 40% by weight to an amount of about 80% by weight of product of a first kind, a final drying in two partial steps is needed or the additional use of a further dehydration means in the packaging.

The amounts of product of a first kind and product of a second kind in the final product can be distinguished in that thanks to the careful final drying step the flavor and/or the color, in particular both, i.e the flavor and the color of the product of a first kind are essentially conserved and/or that it is reduced in fat content compared to a respective product of a second kind. The product of a second kind is not critical if fully dried at higher temperature and may e.g. be fully deep-fried.

The final product preferably is a dehydrated product, especially a snack, with a mean water content of 1 to 4% by weight, in particular 1.5 to 4% by weight, especially 2 to 3% by weight and comprises at least two different kinds of products. From these different kinds of products one corresponds to the further dehydrated product of a first kind and the other one to the product of a second kind with enhanced water content. A preferred dehydrated product comprises products whereof one is not potato chips and/or whereof one is deep-fried and one is only partially deep-fried or preferably not deep-fried.

### EXAMPLE 1

### Vegetable Chips (Laboratory Scale)

Chips of a first kind: Tomato chips

Chips of a second kind: potato chips, standard, salted

Production of the chips of a first kind:
Cutting without pre-treatment; thickness of the tomato pieces after cutting: 6.0 mm
Pre-drying: Conventional air-drying in a belt dryer at 80° C. for 1 hour combined with subsequent vacuum microwave drying for 20 to 30 minutes

Water content after pre-drying: 8.0%

Thickness after pre-drying: irregular in a range of about 1 to about 2 mm

Water content of the potato chips after deep-frying: 1.2%

Mixing ratio: 20% tomato chips, 80% potato chips

Time needed for a full equilibration of the humidity or final drying of the potato chips, respectively: about 2 days at ambient temperature

### EXAMPLE 2

### Meat Chips (Laboratory Scale)

Chips of a first kind: Pork chips

Chips of a second kind: potato chips, standard, salted

Production of the chips of a first kind:
traditional air-drying for 14 days of the previously spiced whole (uncut) piece
Water content of the whole piece of meat after air-drying: 50.0%
Thickness of the meat pieces after cutting: 0.75 mm
Pre-drying: Conventional air-drying in a belt dryer at 80° C. for 15 minutes

Water content after pre-drying: 8.0%

Water content of the potato chips after deep-frying: 1.2%

Mixing ratio: 20% pork chips, 80% potato chips

Time needed for a full equilibration of the humidity or final drying of the meat chips, respectively: about 2 days at ambient temperature

While there are shown and described presently preferred embodiments of the invention, it is to be distinctly understood that the invention is not limited thereto but may be otherwise variously embodied and practised within the scope of the following claims.

1. A method for the production of a dehydration or dry product by dehydration, wherein in a final drying step a product of a first kind with a water content of at least 5% by weight and at most 15% by weight is dehydrated at a temperature of less than 80° C., in particular less than 60° C., much preferred at ambient temperature, at least partially by means of a product of a second kind.

2. The method of claim 1, wherein prior to the final drying step product of a first kind is pre-dried to a water content of at most about 15% by weight, preferably about 5 to about 12% by weight, in particular about 8 to about 10% by weight.

3. The method of claim 1, wherein the product of a first kind is selected from the group consisting of vegetable pieces, fruit pieces, meat pieces, fish pieces and mixtures thereof, in particular from the group consisting of vegetable chips, fruit chips, meat chips, fish chips and mixtures thereof.

4. The method of claim 1, wherein das product of a first kind comprises meat chips or fish chips.

5. The method of claim 4, wherein das product of a first kind comprises meat chips.

6. The method of claim 4, wherein
previous to the pre-drying step the whole piece of meat or fish is subjected to an air-drying step that is performed to a water content of less than 60% by weight, preferably less than 50% by weight and in particular to a water content around about 50% by weight, wherein
the such pre-dried meat or fish is cut into slices of a thickness at of at most 2 mm, preferably 0.3 to 1 mm, in particular 0.5 to 0.7 mm, and wherein
the slices are dehydrated in a dryer to a water content of at most about 15% by weight, preferably to a water content of about 5 to about 12% by weight, in particular to a water content of about 8 to about 10% by weight.

7. The method of claim 1, wherein the product of a first kind comprises vegetable pieces and/or fruit pieces, in particular vegetable chips and/or fruit chips.

8. The method of claim 7, wherein prior to the pre-drying step vegetable and/or fruit are cut into slices of a pre-dried thickness of at most 2 mm, in particular to a thickness in a range of 0.5 to 1 mm, and/or wherein prior to the pre-drying step vegetable and/or fruit are cut into wedges of a variable pre-dried wedge thickness varying from a maximal thickness of at most 20 mm to a minimal thickness of at least 0.5 mm, in particular from a maximal thickness of at most 10 mm to a minimal thickness of at least 0.5 mm.

9. The method of claim 1, wherein the product of a second kind is selected from the group consisting of vegetable pieces, fruit pieces, dough pieces and mixtures thereof, in particular from the group consisting of vegetable chips, fruit chips, dough chips and mixtures thereof, with a water content of less than 3% by weight, preferably at most 2% by weight, in particular about 1% by weight.

10. The method of claim 9, wherein das product of a second kind has been produced by means of deep-frying.

11. The method of claim 9, wherein the product of a second kind comprises potato chips.

12. The method of claim 9, wherein the product of a first kind is used in an amount of up to about 50% by weight or to up to about 30% by weight, referred to the sum of the product of a first kind and the product of a second kind.

13. The method of claim 1, wherein in the final drying step an additional dehydration means is used selected from the group consisting of molecular sieve, silica gel, dry air or a combination thereof, preferably molecular sieve or silica gel.

14. A dehydration product, in particular a snack product, obtained by the method of claim 1.

15. A dehydration product, in particular a snack product, especially a product of claim 14, wherein
(i) the mean water content is 1 to 4% by weight, in particular 1.5 to 4% by weight, much preferred 2 to 3 by weight, and
(ii) said dehydration product comprises at least two kinds of products whereof one is not potato chips and/or whereof one is deep-fried and one is only partially deep-fried or preferably not deep-fried.
